(19) United States
(12) Patent Application Publication
(10) Pub. No.: US 2009/0214114 A1
(43) Pub. Date: Aug. 27, 2009

(54) PIXEL CLASSIFICATION IN IMAGE ANALYSIS

(75) Inventors: Evert BENGTSSON, Uppsala (SE); Carolina WAHLBY, Uppsala (SE); Milan GAVRILOVIC, Uppsala (SE); Joakim LINDBLAD, Uppsala (SE)

Correspondence Address: YOUNG & THOMPSON, 209 Madison Street, Suite 500, ALEXANDRIA, VA, 22314, US

(73) Assignee: DIASCAN AB, Uppsala (SE)

(21) Appl. No.: 12/388,577

(22) Filed: Feb. 19, 2009

(30) Foreign Application Priority Data
Feb. 19, 2008 (SE) 0800373-3

(51) Int. Cl. G06K 9/00

(52) U.S. Cl. 382/170

(57) ABSTRACT

A method for classifying image pixels comprises obtaining (210) of a plurality of pixel vectors of an image. Each said pixel vector has n intensity elements associated with a same respective imaged position, n≧2. Each of the n intensity elements is a digital value representing a discretized intensity measure of light, within a respective predetermined wavelength interval, coming from the imaged position. The method further comprises creating (220) of an angle histogram of angles of the pixel vectors, in a space spanned by unity vectors of the n intensity elements. At least one angle interval is defined (230), corresponding to a respective pixel class, based on statistics of the angle histogram. Pixel vectors are classified based on the defined angle intervals. Co-localization classification insensitive to cross-talk can thereby be obtained. A fluorescence microscopy device having an image analyser according to the method is presented.

### TECHNICAL FIELD

The present invention relates in general to image analysis and in particular to pixel classification.

### BACKGROUND

Highly specific staining methods and fluorescent markers of different wavelengths together with fluorescence microscopy allow for detailed studies of the spatial distribution and localization of biomolecules. In fluorescence microscopy, during image acquisition of multiply labelled specimen, the source of two or more of the emission signals can often be physically located in the same area or very near each other in the final image due to their close proximity within the microscopic structures. This is known as co-localization. Co-localization is particularly important for revealing information on how and where biomolecules such as proteins and protein complexes interact within a cell, as well as in which sub-cellular structures they are present.

Common methods for detection of co-localization are based on intensity thresholding. They are typically user dependent and/or require substantial pre-processing. Also, they typically require images free from cross-talk or images where cross-talk has been eliminated by image processing.

Cross-talk, or bleed-through, is the incomplete separation of fluorescence emission from different flourochromes at image capture. Fluorescence emission intended to be associated with a particular wavelength may therefore give rise to detected intensities also at other wavelengths in a lower or higher degree. This can be caused either by fluorescence emission spectra having components outside the main intended wavelength range and/or by incomplete spectral separation of the different detected wavelengths.

Usually, cross-talk is minimized by changing the way images are captured or by hardware improvements. Therefore, stable methods for suppression of cross-talk are dependent on confocal microscopy image capturing techniques and hardware settings. Hardware solutions for avoiding cross-talk are typically expensive and have to be adapted to the specific image capturing apparatuses.

In “Reduction of cross-talk between fluorescent labels in scanning laser microscopy”, by K. Carlsson and K. Mossberg, in Journal of Microscopy 167(1), pp. 23-37, 1992, a method for partial removal of cross-talk is disclosed. However, remaining cross-talk still causes problems for pixel classification. In “The spectral image processing system (SIPS)—interactive visualization and analysis of imaging spectrometer data”, by F. A. Kruse et al, in Remote Sensing of Environment 44, pp. 145-163, 1993, a basic method for spectral decomposition of multispectral image data is disclosed. However, this approach is interactive and requires substantial inputs from the user. In “Measurement of co-localization of objects in dual-color confocal images”, by E. M. Manders et al, in Journal of Microscopy 169(3), pp. 375-382, 1993, a method for manual detection of co-localization in fluorescence microscopy images is disclosed. Also this method requires manual interaction and requires furthermore images essentially free from cross-talk. In “Automatic and quantitative measurements of protein-protein co-localization in live cells”, by S. V. Costes et al., in Biophysical Journal 86, pp. 3993-4003, 2004, a method for automatic detection of co-localization is disclosed. However, this method requires fluorescence microscopy images free from cross-talk.

A general problem of co-localization analysis in florescence microscopy is that either manual interaction is required or that cross-talk free images have to be provided.

### SUMMARY

A general object of the present invention is thus to provide a stable classification of image pixels based on spectral information that is robust against cross-talk and easily automated.

The above objects are achieved by methods and arrangements according to the enclosed patent claims. In general, according to a first aspect, a method for classifying image pixels comprises obtaining of a plurality of pixel vectors of an image. Each said pixel vector has n intensity elements associated with a same respective imaged position, where n≧2. Each of the n intensity elements is a digital value representing a discretized intensity measure of light, within a respective predetermined wavelength interval, coming from the imaged position. The method further comprises creating of an angle histogram, in (n−1) dimensions, of angles of said pixel vectors, in a space spanned by unity vectors of the n intensity elements. At least one angle interval is defined, corresponding to a respective pixel class, based on statistics of the angle histogram. Pixel vectors are classified in a corresponding pixel class based on the defined angle intervals.

In a second aspect, a fluorescence microscopy device comprises a fluorescence microscope, arranged for providing an image of a sample. The fluorescence microscopy device also comprises intensity measurement means arranged to determine a digital value of discretized intensity measures, within at least two predetermined wavelength intervals, of light coming from an imaged position. The fluorescence microscopy device further comprises an image analyser connected to the intensity measurement means. The image analyser comprises means for obtaining a plurality of pixel vectors from the intensity measurement means. Each pixel vector has n intensity elements associated with a same respective imaged position, where n≧2. The n intensity elements represent the determined digital values. The images analyser further comprises means for creating an angle histogram, in (n−1) dimensions, of angles of the pixel vectors in a space spanned by unity vectors of the n intensity elements. The image analyser also comprises means for defining at least one angle interval corresponding to a respective pixel class based on the angle histogram, and means for classifying pixel vectors in a corresponding pixel class based on the defined angle intervals. The images analyser also comprises means for outputting the classification of the pixel vectors.

One advantage with the present invention is that easily automated pixel classification is provided that is essentially insensitive to cross-talk. Further general advantages and advantages with particular embodiments are discussed in connection with the detailed description.

### BRIEF DESCRIPTION OF THE DRAWINGS

The invention, together with further objects and advantages thereof, may best be understood by making reference to the following description taken together with the accompanying drawings, in which:

FIG. 1A is a diagram illustrating cross-talk in emission spectra;

FIGS. 1B and 1C illustrate detector responses;

FIG. 1D is a scatterplot illustrating points corresponding to spectra of FIG. 1A;

FIG. 2 illustrates a typical example of a scatterplot;

FIG. 3 illustrates an angle histogram;

FIG. 4 illustrates principles for compensation of discretization noise;

FIG. 5 illustrates a weighted angle histogram compensated for discretization noise;

FIG. 6 is a flow diagram of steps of an embodiment of a method according to the present invention;

FIG. 7 is a block diagram of parts of an embodiment of a fluorescence microscope device according to the present invention; and

FIG. 8 is a flow diagram of an embodiment of a part step of FIG. 6.

### DETAILED DESCRIPTION

When analysing light coming from an imaged position, the light has a certain distribution in wavelength. In digital images, each pixel is associated with such an imaged position, which means that each pixel is associated with a certain wavelength distribution. When analysing spectral components of an image, it is common to define one or several predetermined wavelength intervals, within which an intensity is determined. If a complete spectrum is of interest, the wavelength intervals are typically selected border to border, in order to cover the entire range. However, in other applications, the most relevant wavelength regions are selected, neglecting any information in other regions. In fluorescence microscopy, it is e.g. common to record two (or more) greyscale images corresponding to intensities in e.g. the red and green wavelength regions, respectively. The result in any of these cases is that every pixel is associated with at least two values representing an intensity within a respective predetermined wavelength interval, i.e. a pixel vector pᵢ. In other words, each pixel vector pᵢ has n intensity elements p_{i,j}, j=1 . . . n, associated with a same respective imaged position. The number n is equal or larger than 2. Since the image is digital, the n intensity elements p_{i,j} are thus digital values representing a discretized intensity measure of light, within a respective predetermined wavelength interval, coming from the imaged position.

The pixel vectors pᵢ constitute a numerable set of pixel vectors. In a typical case, the pixel vectors represent pixels of a two-dimensional image. However, the general idea of method described in the present invention does not require any particular dimensionality of the image, and the set can represent any plurality of pixel vectors of an image. More particularly, the pixels may represent a one-dimensional image, a two dimensional image or a three-dimensional image. Furthermore, the pixels may also be provided at different time instances for capturing timing effects or e.g. properties during differing outer conditions. The plurality of pixel vectors may therefore represent a single point (pixel) at different times, a one-dimensional image at different times, a two dimensional image at different times or a three-dimensional image at different times.

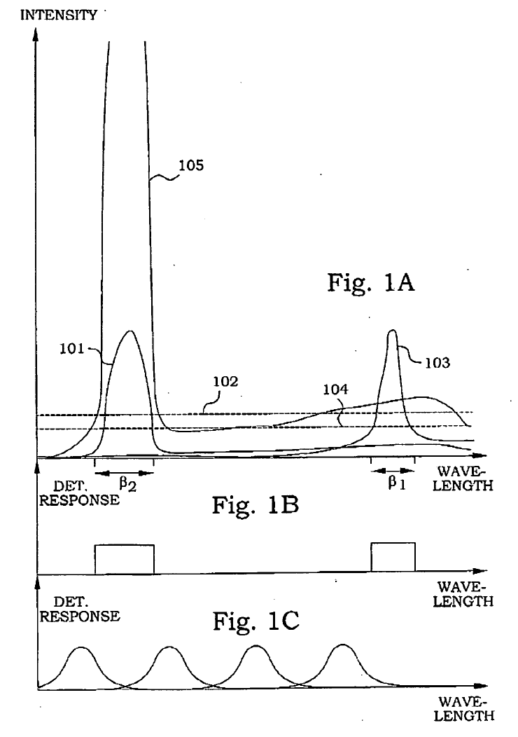

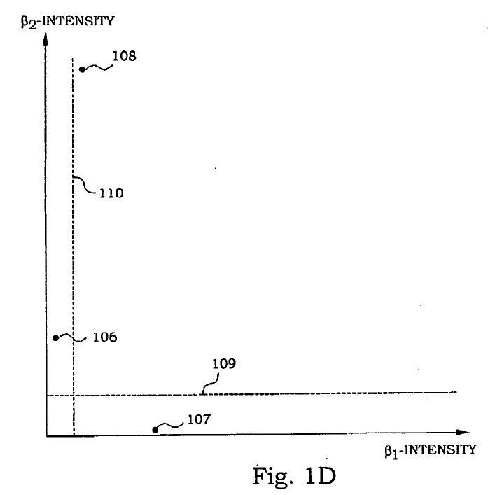

FIG. 1A is a diagram illustrating schematic light spectra obtained from an imaged position. A first spectrum 101 represents light coming from a first imaged position. Within a first wavelength interval β₂, the spectrum has intensities that are considerably higher than outside the interval β₂. If the spectrum 101 is representative for a certain condition at the imaged position, e.g. the presence of a fluorescent element, any such presence can be determined e.g. by assuming that the element is present if the mean intensity within region β₂ is higher than a certain threshold 102. Analogously, a spectrum 103 represents light coming from a second imaged position and has a main intensity within a wavelength interval β₁. A threshold 104, not necessarily equal to the threshold 102, can be used for deciding whether a certain condition is fulfilled at the second imaged position. The detection can e.g. be assumed to be performed within the two wavelength intervals with rectangular response functions, as indicated in FIG. 1B.

One may now notice that even for spectrum 101, there is a small intensity that appears within the wavelength interval β₁. This is an example of cross-talk. However, in most cases, such intensities are so small that they do not reach the threshold 104 and do therefore not considerably influence the analysis. Now, consider an imaged position, where the contribution is similar to the case of spectrum 101, but with a much higher intensity, as illustrated by spectrum 105. In such a case, even the relatively low contribution within the wavelength interval β₁ may be enough to exceed the threshold 104. In such a case, coexistence of the conditions associated with emission in wavelength intervals β₂ and β₁ is erroneously assumed. The cross-talk has thus caused an erroneous conclusion, of e.g. co-localization in a fluorescence microscopy image, when using intensity-threshold based analysis.

In FIG. 1C, detector responses of an application having a multitude of detected wavelength intervals are illustrated. In such a case, the detector response itself has a certain uncertainty, which will cause cross-talk, even with very sharp spectral components to be detected.

The situations corresponding to the three spectra of FIG. 1A are plotted in a so-called scatter plot in FIG. 1D, where the intensities in the two wavelength regions are defined on the axes. The diagram thus represents a space spanned by unity vectors of the two intensities. The three situations are represented by points 106, 107, 108 and the thresholds by lines 109, 110. Point 106 is situated above threshold 109, and the condition (or class) corresponds to 2. Point 107 is situated above threshold 110, and the condition (or class) corresponds to β₁. Point 108 is situated above both thresholds and both conditions are (erroneously) assumed to be present.

The basic ideas of the present invention give possibilities to overcome such difficulties caused e.g. by cross-talk. The ideas are applicable to many different imaging applications, such as different kinds of microscopy or remote sensing by use of images. Even colour treatment of digital photographs may benefit from the presented ideas. The detailed examples described below will, however, be selected from fluorescence microscopy applications, and serve as a model examples. In the model examples, pixel vectors having two elements are discussed, representing two wavelength intervals of green and red light respectively. The more general case of more than two wave length intervals is briefly discussed in the end of the detailed description.

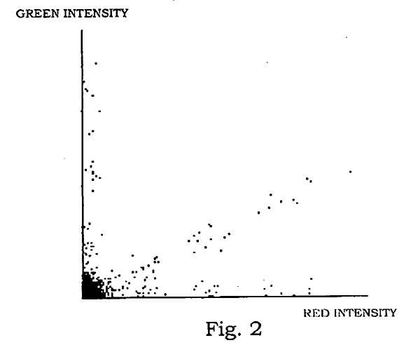

The present invention is based on ideas of spectral decomposition. Spectral decomposition performs pixel classification based on the comparison of angles between vectors representing each pixel in the image. Assume that a set of pixel vectors are available, with pairs of intensity measures of red and green light. From this set of pixel vectors, an angle histogram is created. The angle of the pixel vectors is defined in a two-dimensional space spanned by unity vectors of the two intensity elements, i.e. by axes representing pure red and pure green. The idea behind angle histogram based spectral decomposition is reduction of dimensionality of the data, which can be yielded by transforming an input image into a one-dimensional histogram. If the axes are selected to be perpendicular, the two-dimensional space corresponds to a conventional scatterplot. However, the axes can be selected arbitrarily and may e.g. correspond to the green and red directions in a Hue-Saturation-Intensity diagram. In this embodiment, it is assumed that the pixels with zero of the second vector element corresponds to a spectral angle of 0° and the pixels with zero on the second vector element corresponds to a spectral angle of 90°. An example of a possible such scatterplot is illustrated in FIG. 2.

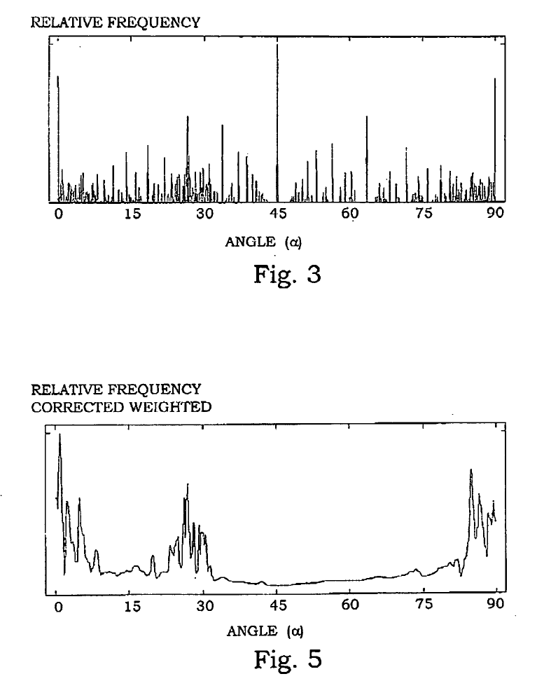

As mentioned above, the pixel vectors are transformed into a histogram, an example of which is illustrated in FIG. 3. The shape of the angle histogram is thereafter examined to detect clusters of pixels with similar spectra. In other words, at least one angle interval is defined, which corresponds to a certain pixel class. This definition is based on the statistics of the angle histogram.

If the image data was analogue, a true angle histogram would result. This is, however, not the case when one is dealing with digital image data. There is an uncertainty associated with each intensity determination, which is at least as large as half the step in the digital intensity values. Furthermore, the relative uncertainty in determining an actual angle is larger for vectors having a short total length compared with vectors having a longer length, i.e. for pixels having a generally low intensity. In a preferred embodiment, the angle histogram is compensated for such discretization noise and intensity dependence. Preferably, a number of processing steps are performed before the angle histogram is used for pixel class definition.

In order to avoid a large impact from pixels having a low intensity, i.e. typically dark background pixels, the contribution from each pixel to the histogram is weighted in order to emphasize pixels with high intensities. The creation of the histogram therefore in the present embodiment comprises weighting a contribution of the angles to the histogram by a factor that is a function of a length of a respective pixel vector. One choice is to scale the contribution with a factor proportional to a Euclidian length of the respective pixel vector.

However, this means that pixels having high intensity in both wavelength intervals will give a larger contribution than pixels having high intensities in only one of the considered wavelength intervals. A more accurate weighting could instead be to weight each pixel with a factor that is proportional to a maximum length of projections of respective pixel vector onto the unity vectors of the two intensity elements. In other words, the Chebyshev distance between the end of the pixel vector and the origin of the scatterplot forms the base of the weighting. This is also known as the chessboard or L_{∞} distance. This also becomes a more sensible distance measure in case of non-Euclidian representations of the angle space. A weighting factor wᵢ could thereby be defined by:

$$\begin{matrix}{w}_{i} = {D}_{Chebyshev} ( ( {p}_{i , 1} , {p}_{i , 2} ) , ( 0 , 0 ) ) \\ = {lim}_{q \to ∞} \sqrt[q]{{\sum }_{j = 1}^{2} {\vert {p}_{i , j} - 0 \vert}^{q}} \\ = max ( {p}_{i , 1} , {p}_{i , 2} ) .\end{matrix} \qquad ( 1 )$$

If the intensities in each intensity element is expressed by a number N_{b} of binary bits, the total intensity range is divided into 2^{N}^{_{b}} intervals represented by the digital values p_{i,j}=0, . . . , 2^{N}^{_{b}}−1. In a digital greyscale image, intensity value p_{i,1} actually represents any of the analogue real numbers ranging from

$${p}_{i , 1} - \frac{1}{2} to {p}_{i , 1} + \frac{1}{2} .$$

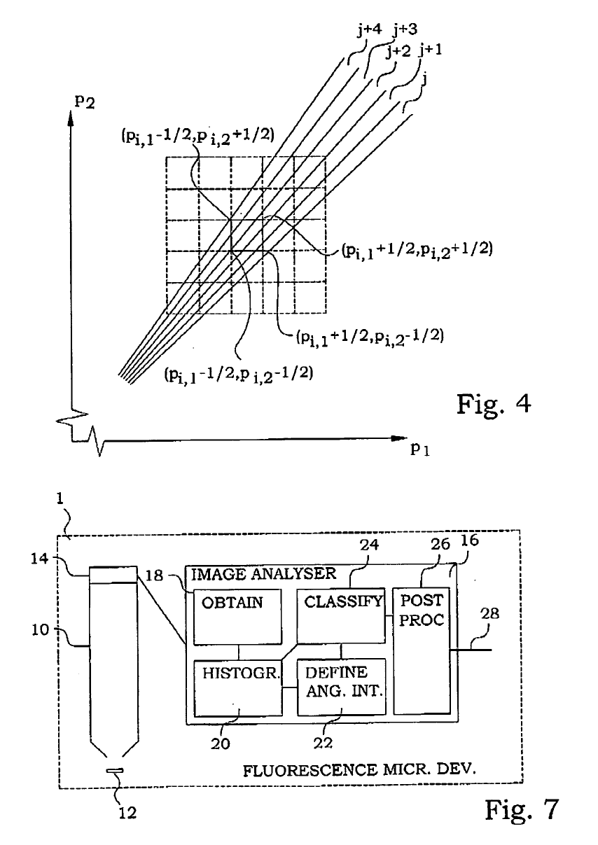

The same is of course true for p_{i,2}. Due to this effect, all vectors pᵢ could be visualized in a 2D Euclidian space as squares. This is illustrated in FIG. 4. If the angle bins of the histogram are large enough in angle range, they may in most cases cover the entire square. However, if the number of angle bins is large in order to avoid loss of information in the image, one square will cross into more than one angle bin range. The contribution from the square should preferably be divided or smeared between the angle bin ranges crossing the square. This is particularly important for vectors having a small total intensity, since they tend to cover a larger angle range. Since there is no additional information about any probability distribution within each square, a reasonable assumption is that there is an equal probability all over the square and the contribution to each angle bin should therefore preferably be proportional to the area portion of the square that each angle bin range covers. Pixel i with intensities (p_{i,1+}p_{i,2}) is distributed among all angles varying from the angle representing the bottom-right corner of the square representing pᵢ to the angle representing top-left corner. This means that the contribution should be distributed to all angles from sufficiently small neighbourhood of arctan

$$( \frac{{p}_{i , 1} - 1 / 2}{{p}_{i , 2} + 1 / 2} )$$

to sufficiently small neighbourhood of arctan

$$( \frac{{p}_{i , 1} + 1 / 2}{{p}_{i , 2} - 1 / 2} ) .$$

If N is the number of angle bins, angles γⱼ, where

$$j = 0 , … , [ \frac{N}{2} ] ,$$

can be defined as increasing linear or arcus tangent function of

$$\frac{j}{[ \frac{N}{2} ]} .$$

A single bin j is defined as the mean of γⱼ₋₁ and γⱼ. Then, the contribution cₚ_{ᵢ}_{,j} of pᵢ to bin j is calculated as the definite integral of:

$${c}_{{p}_{i} , j} = {\int }_{{p}_{i , 1} - 0.5}^{{p}_{i , 1} + 0.5} ( \begin{matrix}max ( {p}_{i , 2} - 1 / 2 , min ( {p}_{i , 2} + 1 / 2 , ( x + 1 / 2 ) tan {γ}_{j} ) ) - \\ min ( {p}_{i , 2} + 1 / 2 , max ( {p}_{i , 2} - 1 / 2 , ( x + 1 / 2 ) tan {γ}_{j - 1} ) )\end{matrix} ) d x , j = 1 , … , [ \frac{N}{2} ] \qquad ( 2 )$$

Contribution values assigned to bins

$$j = [ \frac{N}{2} ] + 1 , … , N$$

are, due to symmetry, equal to contribution values of bin N−j. All definite integrals may preferably be pre-calculated and e.g. stored in an adequate look-up table for easy retrieval.

The total value of bin hⱼ of the angle histogram, if both distance weighting and discretization noise compensation is employed, then becomes:

$${h}_{j} = {\sum }_{i = 1}^{I} {w}_{i} \cdot {c}_{{p}_{i} , j} ,$$

where I is the total number of pixel vectors.

Apart from having correct distribution of spectral angles, benefit of this method is also suppression of basal noise.

The above described approach for compensation of the angle histogram for discretization noise is a presently preferred embodiment. It is in a general description based on smearing of a contribution of a pixel vector to the histogram between histogram bins representing angles falling within discretization uncertainty from respective pixel vector. In particular, an n-dimensional discretization uncertainty volume is calculated around a point in the space spanned by unity vectors of the n intensity elements corresponding to the pixel vector and a pixel fraction is added to a bin of the histogram corresponding to the fraction of the n-dimensional discretization uncertainty volume falling within an angle interval of the bin. The histogram obtains by such a procedure typically a reduced noise level, which makes any statistical treatment of the histogram easier to perform. A histogram after weighting and discretization compensation is illustrated in FIG. 5.

However, other alternative approaches are also possible. One may e.g. calculate the number of angle intervals of histogram bins that passes a point in the space spanned by unity vectors of the n intensity elements corresponding to a pixel vector within discretization uncertainty. In other words, the number of angle bins crossing the discretization uncertainty volume is counted. A pixel fraction is then added to all bins that pass the volume, which fraction is equal to the inverse of the number. The volume is in this approach divided in equal part between the bins (so called super-resolution). This reduces the accuracy somewhat, but reduces also the calculation complexity considerably.

Another approach would be just to calculate an n-dimensional discretization uncertainty volume around a point in the space spanned by unity vectors of the n intensity elements corresponding to the pixel vector. Each discretization uncertainty volume is then divided into a predetermined number of part volumes with a respective centre vector. The histogram can then be created from these centre vectors. This will also mitigate discretization noise somewhat.

Alternative approach could be based on smoothing of uncorrected angle histogram, either uniformly, or in such a way that the radial distance of each point in the space spanned by unity vectors of the n intensity elements corresponding to the pixel vector affects the degree of smoothing applied. This approach would further allow for an appropriate treatment of possible additional uncertainty (beyond quantization noise) in the values of the intensity elements.

When a histogram is created, with or without weighting and/or compensation for discretization noise, the statistics of the histogram is used to proceed with the analysis. At least one angle interval corresponding to a certain respective pixel class is defined. In the above model example of fluorescence microscopy, a typical case would involve three such classes—“red”, “green” and “co-localization”. In the histogram, e.g. of FIG. 5, it can be seen that above a certain background level, mainly created by low-intensity pixels representing background, most of the pixels are gathered in a few angle intervals. In the present example, one group is centred around 5 degrees, which correspond to mainly “red” pixels. Another group is present around 85 degrees, which instead corresponds to mainly “green” pixels. Finally, one group is also present around 25 degrees, which corresponds to pixels having both green and red contributions, i.e. co-localization pixels. By defining three angle intervals corresponding to the classes “red”, “green” and “co-localization” respectively, that enclose the respective group of angles, an association between angle and class is obtained. Pixel vectors having an angle, in the space spanned by unity vectors of the two intensity elements, within one of the three angle intensity intervals are then classified in a corresponding pixel class. If only e.g. “co-localization” is of interest, only one angle interval is necessary to define, leaving the rest of the pixels unclassified.

The actual process by which the angle intervals are defined may be designed in different ways. The exact manner is not of fundamental importance for achieving the technical effect of the present invention, but several alternatives are possible. The approach can advantageously be selected depending on the particular application. One approach is based on identifying distinct angle ranges in the histogram having generally higher amplitudes than surrounding angle ranges and defining the angle intervals to encompass a respective distinct angle range. The procedure of finding such representative angle, i.e. to find a reference pixel vector can be performed by an iterative method. The number of bins is reduced to half. The angle histogram is thereby smoothed by morphological greyscale reconstruction from a mask created by adding dynamics of all peaks to the raw angle histogram. The dynamics is a contrast criterion actually representing a depth of each local minimum of the raw angle histogram. The local minimum is a connected component of bins of constant value whose external boundary bins both have a strictly larger value. The process stops when the number of local maxima is less or equal to the intended number of angle intervals. Preliminary classification rules are representative spectral angles in the last produced angle histogram with minimal values between neighbouring local maxima. The process then preferably continues with analysis of the angle histogram with the original number of bins. Refined representative angles are the angles having the maximal angle histogram value in the corresponding class. Alternatively, a mean or median value within histogram bin exceeding a certain level can be used as a representative angle.

There are also many other prior art approaches for finding representative angles, as such, which can be utilised in this context.

A representative angle in each distinct angle range can thus be selected and borders between neighbouring distinct angle ranges can be defined to cross a middle point of a connection line between a pair of neighbouring representative angles. Another alternative is to place the border at the angle between two angle ranges having the minimum amplitude.

In addition, each angle interval is not limited to be a so called crisp interval, where a specific value is either included or not, but can be any map from the angle domain to a membership to the respective class defined by that interval. This is commonly referred to as a fuzzy interval. For example, the aforementioned representative angles can be defined to map to membership 1 (complete belongingness) for the respective class defining that specific angle and 0 (no belongingness) for all other classes, while the middle point between two representative angles can be mapped to membership 0.5 for both of the involved classes. Angles in between the representative points (having membership 1) and the middle points (having membership 0.5) can be assigned membership values based on e.g. linear interpolation. It is also possible to define each (fuzzy) interval based on a given set of sample images in combination with appropriate statistical or machine learning methods.

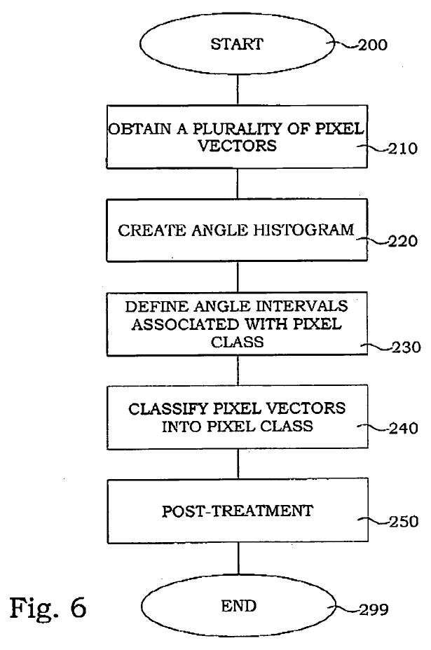

FIG. 6 illustrates a flow diagram of steps of an embodiment of a method for classifying image pixels according to the present invention. The procedure starts in step 200. In step 210, a plurality of pixel vectors of an image is obtained. This can be performed by measuring the intensity from a digital imaging device. It can also be performed by retrieving image data from a data storage, which image data has been recorded at an earlier occasion and/or at another site. In step 220, an angle histogram of pixel vector angles, in a space spanned by unity vectors of the intensity elements, is created. In the present embodiment, the step 220 further comprises compensation of the angle histogram for discretization noise as well as weighting with pixel vector length. A number of angle intervals are defined in step 230, corresponding to a respective pixel class. This defining is based on statistics of the angle histogram. In step 240 pixel vectors are classified in a corresponding pixel class. In one embodiment, pixel vectors having an angle within one of the angle intervals are classified in a corresponding pixel class. Alternative classification embodiments are discussed further below. In this particular embodiment, a step 250 comprising post-treatment procedures are also incorporated in the procedure. Such post-treatment will be discussed further below. The procedure ends in step 299.

FIG. 7 illustrates a block diagram of parts of an embodiment of a fluorescence microscopy device according to the present invention. The fluorescence microscope device 1 comprises a fluorescence microscope 10, arranged for providing an image of a sample 12. The sample is typically stained with fluorescent probes with different light emission characteristics and with affinity for specific components in the sample. The fluorescence microscope device 1 further comprises intensity measurement means 14 arranged to determine a digital value of discretized intensity measures of light coming from an imaged position. An image analyser 16 is connected to the intensity measurement means 14 and receives a plurality of pixel vectors of the image.

The image analyser 16 can be provided in close connection to the fluorescence microscope 10 or distant therefrom. However, the data of the pixel vectors should be transferable from the intensity measurement means 14 to the image analyser 16. The image analyser 16 is typically constituted by a processor, a part of a processor or a processor group. The image analyser 16 in such an embodiment comprises different software code enabling image analysing routines to be performed on the processor. The different routines therefore constitute different means for performing different tasks, even if there is no explicit physical division between the different means. The image analyser 16 of the present embodiment thereby comprises means 18 for obtaining a plurality of pixel vectors from the intensity measurement means according to the principles discussed further above. The image analyser 16 further comprises means 20 for creating an angle histogram of said pixel vectors and is therefore communicationally connected to the means 18 for obtaining a plurality of pixel vectors. In the present embodiment, the means 20 for creating an angle histogram is arranged for compensation of the angle histogram for discretization noise as well as weighting the pixel vector contributions based on intensity.

The image analyser 16 further comprises means 22 for defining angle intervals corresponding to a respective pixel class. The definition is based on the angle histogram and the means 22 for defining angle intervals is therefore connected to the output of the means 20 for creating an angle histogram. The output of the means 22 for defining angle intervals as well as the output of the means 20 for creating an angle histogram are connected to means 24 for classifying in a corresponding pixel class. In one embodiment, pixel vectors having an angle within one of the angle intervals are classified in a corresponding pixel class. Alternative classification embodiments are discussed further below. A means 26 for postprocessing, the operation of which will be described further below, is in the present embodiment connected to the means 24 for classifying pixel vectors. Means 28 for outputting the classifying of the pixel vectors is finally provided.

In the image analysis described so far, only classification into classes having particular specified spectral properties is made. This means that in an image, also pixels with low intensity, e.g. general background pixels typically also are classified into one of the classes giving an intensity independent classification. In additional processing steps other criteria such as intensity or spatial properties can be used for further classification. One approach is to again consider the intensities or length of the vectors and classifying pixel vectors having a small length as background. Pixel vectors having small intensities in all elements, in the example above both a small red and green intensity, do typically not provide any useful information and may be dispatched as “background pixels”. An additional classification as background could then be based directly using the element values of the pixel vectors. In one embodiment, a common threshold can be used for all elements. For more general purposes, one threshold for each element can be used. Also other approaches, such as a threshold for a Euclidian or Chebyshev length of the pixel vector can also be utilized.

A background classification can also be performed based on a cluster analysis on classified pixel vectors. Clusters of pixels having the same classification can then be identified and pixel vectors falling outside the clusters can consequently be reclassified as background.

When defining angle intervals corresponding to the “pure” elements, information about the actual cross-talk present in the data can be obtained. In the example of red, green and co-located fluorescence pixels, one can see that the representative angle of the “pure” colours is not situated in immediate vicinity of a respective axis of the scatterplot. This means that a pixel showing only “red” emitted light anyway contributes to the “green” intensity and vice versa. In other words, the larger the angle difference between the representative angle and the corresponding scatterplot axis is, the larger is the cross-talk. If the smallest representative angle is α₁ and the largest representative angle is α₂, the cross-talk or bleeding from the second channel to the first is equal to tan(α₁) and from the first to the second tan(90−α₂). By expressing the pixel vectors as linear combinations of these respective representative angle vectors, a greyscale image compensated for cross-talk is produced. This can also be seen as transforming the pixel vectors into a space spanned by the representative angle vectors as axes.

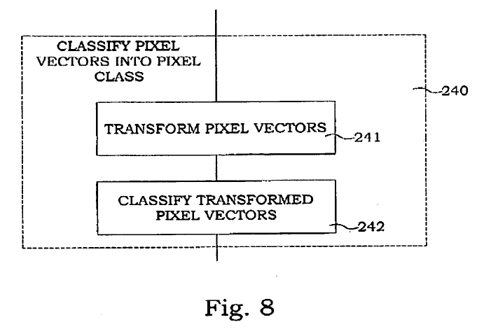

In one alternative embodiment of the present invention, the classification is performed as a composite step of a cross-talk removal step and an ordinary classification step as illustrated by FIG. 8. If a scatterplot is created using the pixel vectors as expressed in terms of the representative angle vectors of the “pure” colours, such a scatterplot will be essentially free from cross-talk. In other words, the pixel vectors are transformed 241 into having elements as defined by the representative angle vectors. It would therefore be possible to apply any prior art classification techniques 242. For instance, if cross-talk is removed from the input pair of greyscale images, detection of co-localization can be provided using some classical methods for automatic thresholding of both channels. Pixels below both thresholds are classified as basal noise, pixels below the second threshold and above the first threshold as belonging to the first channel colour, pixels below the first threshold and above the second as belonging to the second channel colour and pixels above both thresholds as co-localized. However, one should bear in mind that the angle histogram and the angle intervals nevertheless is necessary in order to create the means for removing the cross-talk. In such a case, only angle intervals for “pure” colours have to be defined, since e.g. co-localization can be defined after the cross-talk removal.

In the exemplifying embodiment above, three classes, plus a background classification, are typically used. However, if e.g. only co-localization is of interest to classify, there is no need to create angle intervals corresponding to the pure colours (if not cross-talk removal is to be performed). All pixels falling outside that co-localization angle interval can be neglected or treated as background.

In some cases, there might also be more than one type of co-localization present. It can e.g. be of interest to distinguish between co-localization with different relative concentration. For instance, if two red markers are co-localized with one green marker, such situation may be of interest to distinguish from a case where one marker of each colour is present. In such a case, more than three angle intervals may be defined, e.g. corresponding to the pure colours and co-localization with different marker ratios.

In the example above, two basic colours are considered to represent two wavelengths, i.e. the pixel vectors have two elements. However, the present invention is also applicable on pixel vectors of higher dimensionality. If e.g. markers of three different wavelengths are available, three greyscale images corresponding to one wavelength each can be obtained and considered as a set of pixel vectors having three elements. In such a case, the angle histogram will also acquire a higher dimensionality. If the pixel vector has three elements, the angle histogram will be a two-dimensional histogram. Such a histogram may be visualized on a spherical surface, with the axes corresponding to the “pure” colours for each wavelength being directed in three linearly independent directions. Definitions of angle intervals will then also be performed in two dimensions, and the borders between angle intervals will be borders at a two-dimensional surface.

This can of course be generalized into any number n of pixel vector elements, which gives angle histograms, angle intervals and borders in (n−1) dimensions. The approaches for visualizing the results becomes more complex since the human brain is typically restricted to three-dimensional visualization, but the corresponding mathematical operations are indeed possible to perform anyway.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. Method for classifying image pixels, comprising the step of:
obtaining a plurality of pixel vectors of an image,
each said pixel vector having n intensity elements associated with a same respective imaged position, where n≧2;
each of said n intensity elements being a digital value representing a discretized intensity measure of light, within a respective predetermined wavelength interval, coming from said imaged position;
classifying pixel vectors based on at least one angle interval;
creating an angle histogram, in n−1 dimensions, of angles, in a space spanned by unity vectors of said n intensity elements, of said pixel vectors, said angles being defined relative to said unity vectors; and
defining said at least one angle interval corresponding to a respective pixel class, based on statistics of said angle histogram in n−1 dimensions.

2. Method according to claim 1, wherein said step of creating comprises compensation of said angle histogram for discretization noise.

3. Method according to claim 1, wherein said image is a fluorescence microscopy image.

4. Method according to claim 1, wherein said step of creating further comprises weighting a contribution of said angles to said histogram by a factor being a function of a length of the respective pixel vector.

5. Method according to claim 4, wherein said factor is proportional to a maximum length of projections of respective pixel vector onto said unity vectors of said n intensity elements.

6. Method according to claim 4, wherein said factor is proportional to a Euclidian length of respective said pixel vector.

7. Method according to claim 2, wherein said compensation of said angle histogram for discretization noise comprises smearing of a contribution of a pixel vector to said histogram between histogram bins representing angles falling within discretization uncertainty from respective said pixel vector.

8. Method according to claim 2, wherein said step of creating an angle histogram comprises smoothing of said angle histogram.

9. Method according to claim 1, wherein said plurality of pixel vectors representing imaged positions of an image of at least one spatial dimension.

10. Method according to claim 1, wherein said plurality of pixel vectors representing discretized intensity measures obtained at different time instances.

11. Method according to claim 1, wherein said at least one angle intensity interval comprises at least one fuzzy angle interval.

12. Method according to claim 1, wherein one said pixel class is associated with co-localization.

13. Method according to claim 1, wherein said step of defining at least one angle interval corresponding to a respective pixel class comprises:
identifying at least one distinct angle range in said histogram having generally higher amplitudes than surrounding angle ranges; and
defining said angle intervals to encompass a respective said distinct angle range.

14. Method according to claim 13, wherein said defining of said angle intervals comprises:
selecting a representative angle in each said at least two distinct angle ranges; and
defining borders between neighbouring said at least two distinct angle ranges to cross a middle point of a connection line between a pair of neighbouring representative angles.

15. Method according to claim 1, further comprising having one class corresponding to each of a pure intensity element and by:
selecting a representative pure element angle in each distinct angle range corresponding to a respective pure intensity element; and
quantifying a cross-talk between said pure intensity elements as an angle difference between said representative pure element angle and corresponding intensity element axis.

16. Method according to claim 15, further comprising compensating cross-talk based on said cross-talk quantifications.

17. Method according to claim 1, further comprising:
selecting a representative pure element angle in each distinct angle range corresponding to a respective pure intensity element; and
transforming said pixel vector to be expressed as linear combinations of said representative pure element angle vectors;
performing pixel vector classification on said transformed pixel vectors.

18. Method according to claim 1, further comprising classifying pixel vectors having a small length as background.

19. Method according to claim 1, further comprising performing cluster analysis on classified pixel vectors and classifying pixel vectors falling outside said clusters as background.

20. Fluorescence microscopy device, comprising:
a fluorescence microscope, providing an image of a sample;
intensity measurement means arranged to determine a digital value of discretized intensity measures, within at least two predetermined wavelength intervals, of light coming from an imaged position; and
an image analyser connected to said intensity measurement means, said image analyser comprising:
means for obtaining a plurality of pixel vectors from said intensity measurement means,
each said pixel vector having n intensity elements associated with a same respective imaged position, where n≧2;
said n intensity elements representing said determined digital values;
means for creating an angle histogram, in n−1 dimensions, of angles, in a space spanned by unity vectors of said n intensity elements, of said pixel vectors, said angles being defined relative to said unity vectors;
means for defining at least one angle interval corresponding to a respective pixel class, based on said angle histogram in n−1 dimensions;
means for classifying pixel vectors in a corresponding said pixel class based on said at least one angle interval; and
means for outputting said classifying of said pixel vectors.
